(19) United States
(12) Patent Application Publication
(10) Pub. No.: US 2005/0270624 A1
(43) Pub. Date: Dec. 8, 2005

(54) Torsional hinge MEMS device with maximum hinge stress on a polished surface

(76) Inventors: John W. Orcutt, Richardson, TX (US); Andrew Steven Dewa, Plano, TX (US); Arthur Monroe Turner, Allen, TX (US); Mark W. Heaton, Irving, TX (US)

Correspondence Address: TEXAS INSTRUMENTS INCORPORATED, P O BOX 655474, M/S 3999, DALLAS, TX, 75265, US

(21) Appl. No.: 10/861,947

(22) Filed: Jun. 4, 2004

(51) Int. Cl. G02B 26/00; G02F 1/07

(52) U.S. Cl. 359/291

(57) ABSTRACT

A robust torsional hinged device and a method of fabricating the device are disclosed. Unlike the prior art torsional hinged devices, the width “W” of the hinge is selected to be greater than the thickness “T” of the silicon wafer from which the torsional hinged device is etched. Therefore, since the top and bottom surfaces of the silicon wafer are polished, the larger dimension of the rectangular cross-sectional hinge lies along a polished surface rather than the rougher etched surface. Since the roughness or striations act as stress concentration and since the greater stress levels of a torsional hinge lie along the largest dimension, a more robust hinge is obtained.

### TECHNICAL FIELD

The present invention relates generally to the field of torsional hinge MEMS oscillating devices. More particularly, the invention relates to a method of fabricating a torsional hinge device such as an oscillating mirror so that the maximum stress experienced by the hinge is on a polished surface rather than the rougher etched surfaces or sidewalls. The torsional hinged devices are etched from a silicon wafer having at least one polished surface and using readily available semiconductor manufacturing and etching techniques.

### BACKGROUND

Recently, inexpensive torsional hinged flat mirrors with a single reflective surface have gained acceptance as a reliable replacement scanning mirror for the much more expensive rotating polygon mirrors used in laser printers. Laser printers use a scanning mirror to provide a continuous sweep or scan of a modulated light source across a photosensitive medium such as a rotating drum. By designing the torsional hinged mirror to have a resonant frequency substantially at the desired scanning or sweep frequency of the laser beam, these torsional hinged mirrors are used in new generations of high-speed laser printers at a very advantageous cost.

These mirrors as presently designed have a very long life and are robust once mounted in place when compared to rotating polygon mirrors. However, as will be appreciated by those skilled in the art, that depending of the design of the hinge, the torsional hinges may be subjected to very high stresses and represent a point of failure. Therefore, it should be appreciated that a design change of the torsional hinge(s) that substantially reduces failure without substantially increasing cost would be advantageous.

Texas Instruments presently manufactures a large number of mirror MEMS devices fabricated or etched from a single piece of material (such as a silicon wafer for example) typically having a thickness “T” of about 100 to 115 microns using semiconductor manufacturing processes. Before the mirror devices are etched, at least one surface (and usually both) of the silicon wafer is polished to provide the reflective surface of the mirror, which may have any suitable perimeter shape such as oval elongated elliptical, rectangular, square or other. Single axis mirrors include the reflective surface portion and a pair of torsional or full hinges, which extend to a support frame or alternately the hinges may extend from the mirror portion to a pair of hinge anchors.

Regardless of the type of torsional hinge supporting the mirror (or device), it will be appreciated that, in addition to such material characteristics as the Youngs modulus of silicon, the resonant frequency of a torsional hinge device is determined by the thickness “T”, the width “W”, and the length “L” of the hinge(s). Therefore, since the hinges are formed by etching through the silicon wafer, the cross-section of the hinge will typically be rectangular with dimensions “T” and “W” where the thickness “T” is the same as the thickness “T” of the wafer. The width “W” of the hinge is then selected along with the hinge length “L” to provide the desired resonant frequency. Therefore, since resonant frequency of the mirror is set by T, W, and L, it will be appreciated that if the design of the mirror changes, T, W and L may have to be adjusted to get the desired resonant frequency. T, W, and L, of course, have almost an infinite number of combinations that will produce the same resonant frequency. The stress seen by the torsional hinges is a function of the angle of rotation of the mirror, and at rest, there is a minimal hinge stress. As the mirror rotates, the stress increases as a function of the angle of rotation. A mirror running at 10 degrees deflection will have many times the hinge stress as the same mirror running at 1 degree deflection. If the hinge stress at the maximum angle is too great, the hinge can be made longer and the other dimensions adjusted as necessary. A solution can usually be reached by working the wafer thickness T, and hinge length L.

As will be appreciated by those skilled in the art, the process of etching through a silicon wafer often leaves a somewhat rough or striated surface. Therefore, as will further be appreciated, the sides of the hinge along the dimension “T” or thickness will be noticeably rougher than the top surface of the hinge, which as was discussed above, has been polished to provide the mirror surface. Since both the top and bottom surface of a wafer are typically polished, the sidewalls of the hinge are usually rougher than both the top and bottom surface. It is also known that the sidewall striations left from the etching process will act as stress concentrators and will likely be the failure point if the mirror does fail.

### SUMMARY OF THE INVENTION

These and other problems are generally solved or circumvented, and technical advantages are generally achieved, by embodiments of the present invention, which provide a torsional hinged device, such as a mirror, that reduces the effects of stress concentrating surface flaws or striations in the torsional hinge. The torsional hinged device is etched from a silicon wafer having a thickness “T” and at least a polished top surface. Typically, however, both the top and bottom surfaces will be polished. The silicon device includes an anchor member, such as attaching pads or a frame, and a functional portion such as a mirror or reflecting surface. At least one torsional hinge extends between the anchor member and the functional surface or mirror. The torsional hinge typically has a rectangular cross-section with a thickness dimension “T” and a width “W”. The top and bottom surfaces of the hinge correspond to the top and bottom polished surfaces of the silicon wafer such that the dimension “T” of the hinge is the same as the thickness “T” of the silicon wafer. Unlike the prior art, the width dimension “W” of the hinge is greater than the thickness dimension “T”. Therefore, since the widest side of the hinge experiences the highest stress levels, designing the hinge to have a greater width than thickness moves the highest stress levels to the smoothest surface and away from the stress concentrating striations.

The mirror size, the mass angle of rotation, wafer thickness and the desired resonant frequency are examples of factors that determine the dimension of the torsional hinge that supports a mirror. Since the polished top and bottom surfaces have fewer striations or stress concentrators than the rougher etched surfaces, it is believed that the larger hinge dimension should be the width “W” such that the ratio W/T is equal to or greater than about 1.1. Therefore, as an example only, since presently available silicon wafers have a lower thickness limit of between about 75 microns and 100 microns, the “W” of the hinge of a mirror made from such a wafer should be selected to be no less than about 82.5 microns and 110 microns.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIGS. 1A through 1E illustrate embodiments of single axis full torsional hinged mirrors that can benefit from the teachings of the present invention;

FIGS. 2A through 2D illustrate the embodiments of dual axis full torsional hinged mirrors that can benefit from the present invention;

FIGS. 3A through 3D illustrate the embodiments of single axis half torsional hinged mirror that can benefit from the teachings of the present invention;

FIGS. 4A, 4B, and 4C illustrate typical embodiments of drive mechanism suitable for use with the present invention;

FIG. 5 illustrates a torsional hinge according to the prior art; and

FIG. 6 illustrates a torsional hinge according to the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Like reference number in the figures are used herein to designate like elements throughout the various views of the present invention. The figures are not intended to be drawn to scale and in some instances for illustrative purposes, the drawings may intentionally not be to scale. One of ordinary skill in the art will appreciate the many possible applications and variations of the present invention based on the following examples of possible embodiments of the present invention.

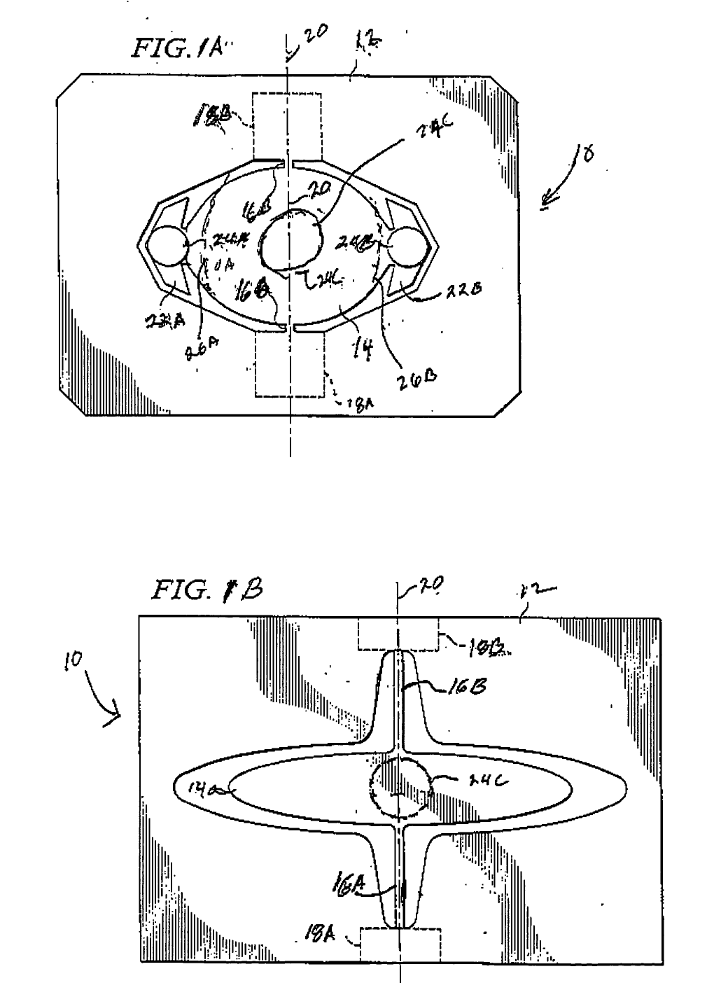

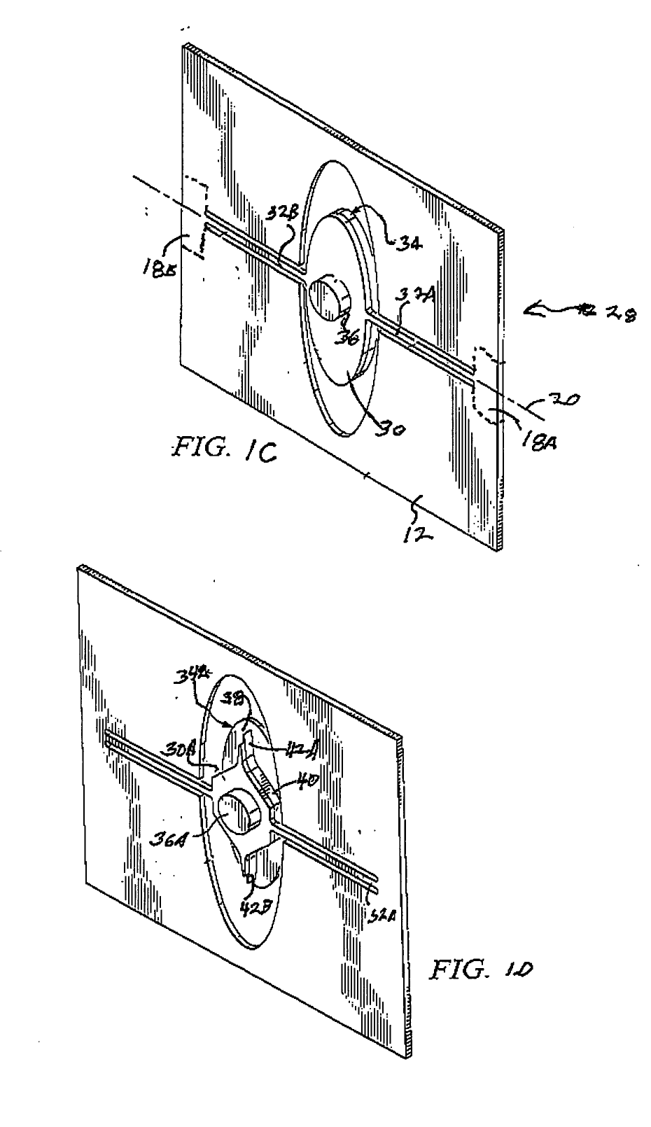

Referring now to the prior art FIG. 1A, mirror device 10 includes a functional surface, such as a reflective surface or mirror 14, supported by a pair of torsional hinges 16a and 16b. A frame member 12 or alternately, a pair of anchor pads 18a and 18b, supports the device 10 along a selected axis 20. According to one embodiment, the mirror device 10 may also include a pair of tabs 22a and 22b for supporting a pair of magnets 24a and 24b used to pivot the reflecting surface or mirror member 14 about selected axis 20. Alternately, the tabs may be omitted as indicated by dashes lines 26a and 26b and a single magnet 24c may be bonded to the back side of the pivoting reflecting surface 14.

Referring now to FIG. 1B, there is shown another embodiment of a typical single axis mirror device. The mirror shown in FIG. 1B is substantially similar to that shown in FIG. 1A except the mirror portion 14a has a long elliptical shape. Consequently, FIG. 1B uses the same reference number as FIG. 1A to identify similar components of the mirror. The mirror of FIG. 1B could be driven by permanent magnets attached to the tips of the elongated ellipse, but is shown with a center magnet 24C.

Referring to FIG. 1C, there is shown an assembled view of a single axis multilayered device having a scanning mirror as the functional surface. This multilayered mirror solves the conflicting needs of flexible hinges and a rigid or flat mirror surface. As shown, the multilayered scanning structure comprises a support structure or hinge layer 28 for pivotally supporting attaching member 30 having a front side and a back side connected to an anchor member 12 by a pair of torsional hinges 32a and 32b. Anchor member 12 is a frame as shown in the multilayered device of FIG. 1C. However, anchor member 12 could be replaced by a pair of anchor pads 18a and 18b as indicated by the dotted lines and as was discussed above with respect to FIGS. 1A and 1B. The functional portion, such as mirror portion 34, has a front reflecting surface and a back surface. The back surface is bonded or mounted to the front side of the attaching member 30 and a back portion such as, for example only, permanent magnet 36, is bonded or mounted to the back side of the mirror attaching member 30. As shown, permanent magnet 36 is bonded along the axis 20 to the center of the back side of mirror attaching member 30. Permanent magnet 36 is considerably stiffer than the hinge layer 28 and mirror portion 34 and consequently stiffens and reinforces the structure in the middle area where the magnet is located. In addition, the mass of the permanent magnet 36 times the offset distance of the center of mass of the permanent magnet 36 from axis 20 is selected to be substantially equal to and opposite the mass of mirror portion 34 times the offset distance of the center of mass of mirror portion 34 from axis 20, such that the moment of inertia of the device is centered on the primary pivoting axis 20 on the center line of the hinges. The front layer, or mirror portion 34 and permanent magnet 36 of the assembled structure of FIG. 1C, add significant weight that must be supported by the torsional hinges 32a and 32b. However, if the entire front layer or mirror portion were made thick enough to maintain an acceptable level of flatness, the increased weight would be even greater, such that the hinges would likely be under additional stress. Therefore, the torsional hinges of a mirror would likely nee to be redefined such as by lengthening the hinge and changing its width. Otherwise, this added stress due to such an increase in weight could result in unacceptable failure rates and short life.

If a device, such as a mirror, is to pivot or resonant at high-speed with minimal drive energy requirements and avoid excessive stress, engineering principles immediately suggest reducing the mass and weight of the oscillating device. However, reducing the mass of the device typically means thinning down the structure, and as discussed above, a thin structure also means a structure that is not as rigid (i.e., is flexible), and, as discussed above, a device, such as a mirror, that is too flexible is also unacceptable.

Therefore, referring to FIG. 1D and according to another embodiment of the invention, there is shown an assembled view representing an optimized multilayered resonant device having a mirror as the functional surface. The device of FIG. 1D has the same basic components as the device of FIG. 1C including mirror layer 34a. However, mirror layer 34a has a reflecting portion 38 with a first thickness and a back portion 40 defining at least one reinforcing ridge or member, such as for example, spines 42a and 42b that extend substantially to the edges or tips of the reflecting portion 38. Spines 42a and 42b are of course only examples, and the device could define two, three or more spines (not shown) extending from the hinge axis to the edges of the reflecting portion 38. Further, the spines or reinforcing ridges may have other shapes and may be formed by any suitable method such as controlled deposition or etching to remove excess material. Thus, the absence of material at large areas of the mirror layer 34a reduces weight and mass while the formed spines or reinforcing or stiffening members 42a and 42b help maintain a satisfactory degree of stiffness. Similarly, material may also be removed or etched from the attaching member 30a of the hinge layer 28 to define a shape that is similar and substantially matches the shape of the back portion 40 of the mirror layer 34a. Finally, the diameter of the rigid permanent magnet 36a may be increased and the thickness reduced to provide still more rigidity or stiffness to the structure in the hinge area. It will also be appreciated as was the case in the embodiment of FIG. 1C, that the mass of magnet 36a times the offset distance of the center of the mass of magnet 36a from axis is balanced with the mass of mirror layer 34a times the offset distance of the center of the mass of mirror layer 34a from axis 20.

In addition to a pivoting device having a magnetic drive as shown in FIGS. 1C and 1D, the basic concepts discussed with respect to these figures are also applicable to resonant mirrors using an inertia drive such as could be provided by a piezoelectric device. Therefore, referring to FIG. 1E, there is shown an assembled view of a multilayered device similar to that illustrated in FIG. 1D having a resonant mirror as the functional surface that would be suitable for use with a piezoelectric drive (not shown). Those elements of the structure that are equivalent to the elements of FIGS. 1C and 1D carry the same reference numbers. Therefore, as shown, the embodiment of 1E differs with respect to FIGS. 1C and 1D in that the back portion attached to the attaching member 30a is a back layer 44 made of a material such as silicon rather that the permanent magnet 36. Further shown in FIG. 1E, the back layer 44 may also be etched or have material removed such that it matches the etched attaching member 30a of hinge layer 28. Likewise, the front or mirror layer 34a of the embodiment of FIG. 1E may simply be a flat portion as shown or may also have spines formed thereon as discussed with respect to FIG. 1D that also matches the shape of the spines on the attaching member 30a of the hinge support portion or layer 28.

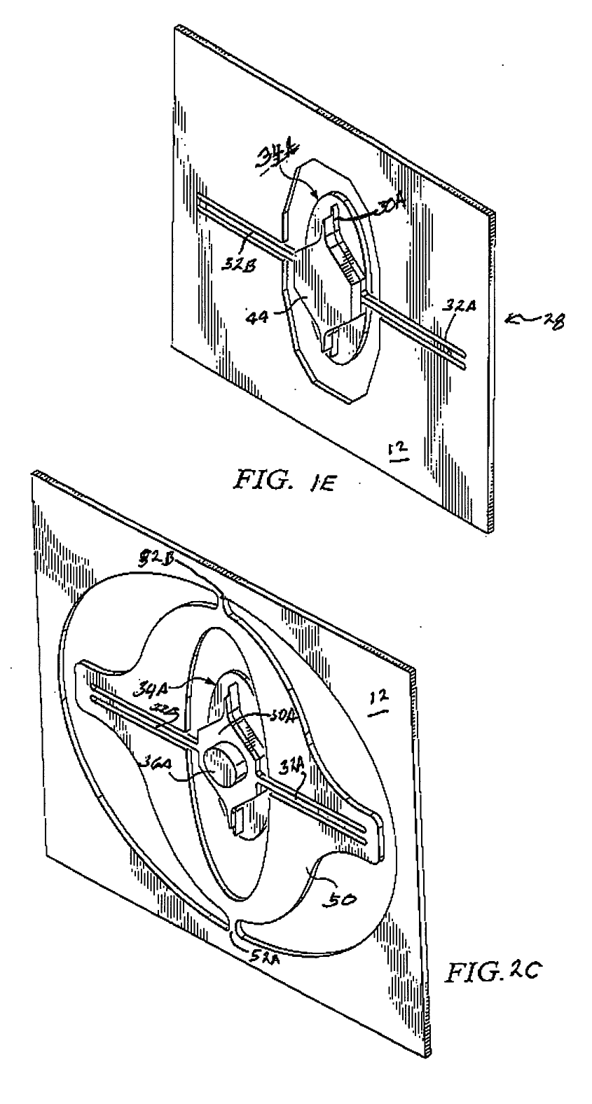

Referring now to FIGS. 2A and 2B, there is shown a perspective view and a top view, respectively, of two different embodiments of a dual axis of bi-directional device having a functional surface or mirror 14. Such dual axis mirrors may be used to provide a high-speed beam sweep wherein the high-speed beam sweep is also adjusted in a direction orthogonal to the beam sweep. When used as a scanning engine for a printer, adjusting the beam sweep orthogonally allows the printed image lines produced by a beam sweep in one direction and then in a reverse direction to be maintained parallel to each other. As shown, the assemblies of both FIGS. 2A and 2B are illustrated as being mounted on a support 46 and suitable for being driven along a second axis 48 as well as axis 20. As was discussed above with respect to single axis resonant devices, the mirror assembly may be formed from a substantially planar material and the functional or moving parts may be etched in the planar sheet of material (such as silicon) by techniques similar to those used in semiconductor art. As shown, the functional components include a support member or frame portion 12, similar to the single axis device. However, unlike the single axis device, the support structure of the dual axis device also includes an intermediate gimbals portion 50 as well as the functional surface such as mirror portion 14. It will be appreciated that the intermediate gimbals portion 50 is hinged to the support member or frame portion 12 at two ends by a pair of torsional hinges 52a and 52b spaced apart and aligned along axis 48. Except for the pair of hinges 52a and 52b, the intermediate gimbals portion 50 is separated from the frame portion 12. It should also be appreciated that, although support member or frame portion 12 provides an excellent support for attaching the device to support structure 46, it may be desirable to eliminate the frame portion 12 and simply extend the torsional hinges 52a and 52b and anchor the hinges directly to the support 46 as indicated by anchors 18a and 18b show in dotted lines on FIGS. 2A and 2B.

The inner, centrally disposed functional surface or mirror portion 14 is attached to gimbals portion 50 at hinges 16a and 16b along an axis 20 that is orthogonal to or rotated 90° from axis 48. The functional surface or mirror portion 14 for the embodiment shown is suitably polished on its upper surface to provide a specular or mirror surface. If desired, a coating of suitable material can be placed on the mirror portion to enhance its reflectivity for specific radiation wavelengths.

The embodiments of FIGS. 2C and 2D are similar to the apparatus shown in FIG. 2B except it is multilayered and the mirror attaching member and the mirror portion or layer has been optimized by removing or etching excess material in the same manner as was discussed above with respect to FIGS. 1D and 1E.

Referring now to FIGS. 3A through 3D, there are shown still other embodiments of a torsional hinge mirror that can benefit by incorporating the teachings of the present invention. As shown, FIGS. 3A and 3C are single layered structures and the embodiments of FIGS. 3B and 3D are multilayered structures such as discussed above. As shown in FIGS. 3A and 3B, there is an elongated ellipse mirror portion 56 supported by a single torsional hinge 58. The other end of the torsional hinge is part of an anchor member 60. The anchor member 60 as was discussed heretofore, may include a complete frame around the mirror structure, or simply be an anchor pad as shown in both FIGS. 3A and 3B. Also included on the bottom side of the elongated ellipse portion 56, as illustrated by dashed line, is a single permanent magnet 62 for providing pivotal forces. Thus, as seen, the mirror structure of FIGS. 3A and 3B will pivot around pivot axis 20 on single torsional hinge 58 at a selected frequency, and preferably at the resonant frequency of the torsional mirror and hinge structure. Mirror structures similar to that shown in FIGS. 3A and 3B have been found to reach a resonant frequency and operate quite satisfactorily. However, as will be appreciated, because the mirror portion is supported as a cantilever member by the torsional hinge 58, the mirror is susceptible to forces in a plane perpendicular to the axis 20 of the mirror device. Consequently, as shown in FIGS. 3C and 3D, there are illustrated mirror structures substantially similar to those discussed with respect to FIGS. 3A and 3B. However, the embodiments shown in FIGS. 3C and 3D further include an axial member 64 extending along the selected axis and away from the mirror structure. As shown, the axial member 64 does not include another anchor pad but will be supported in a plane perpendicular to the axis as illustrated.

In the embodiment illustrated in FIG. 3C, the anchor pad 60 will be attached to a supporting structure (not shown) and the extreme end 66 of the axial member 64 may lay in a groove 68 on top of another portion 70 of the support member and then held in place via an axial hub or support member 72. Thus, the axial member 64 is free to rotate, but is substantially restrained from movement in a plane perpendicular to the selected axis 20.

It will also be appreciated by those skilled in the art that the support structure may simply comprise a hole or aperture 74 drilled into the support structure for receiving the extreme end of the axial member 64 such as shown in FIG. 3D.

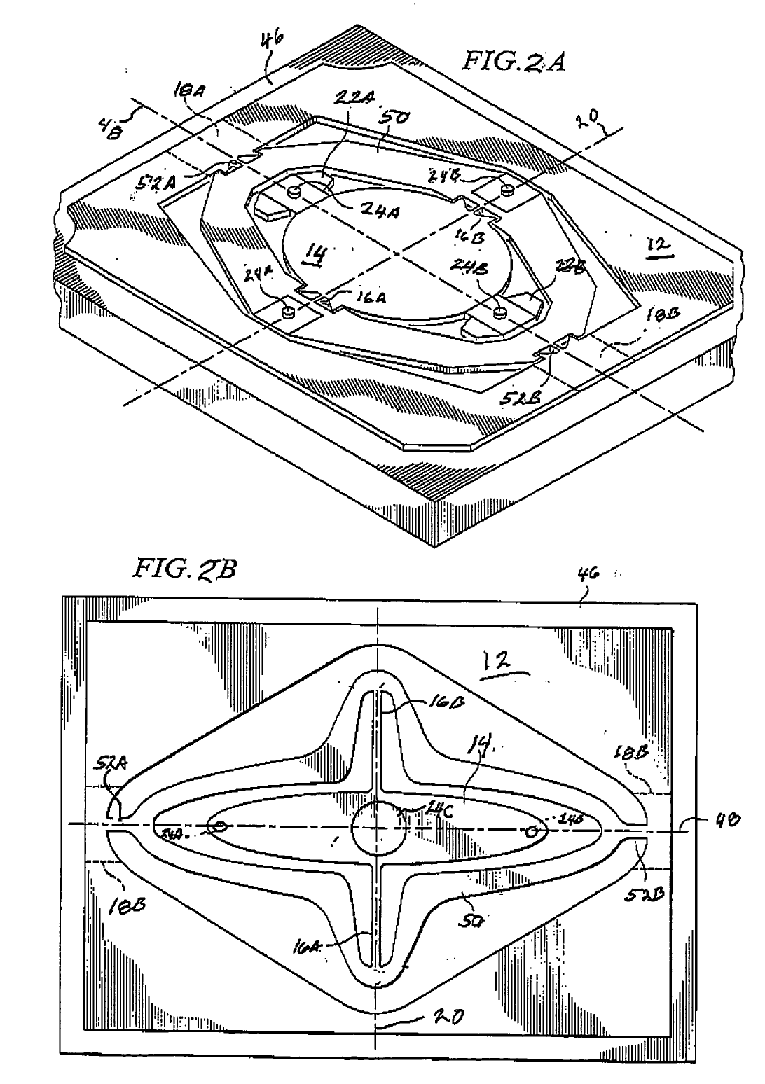

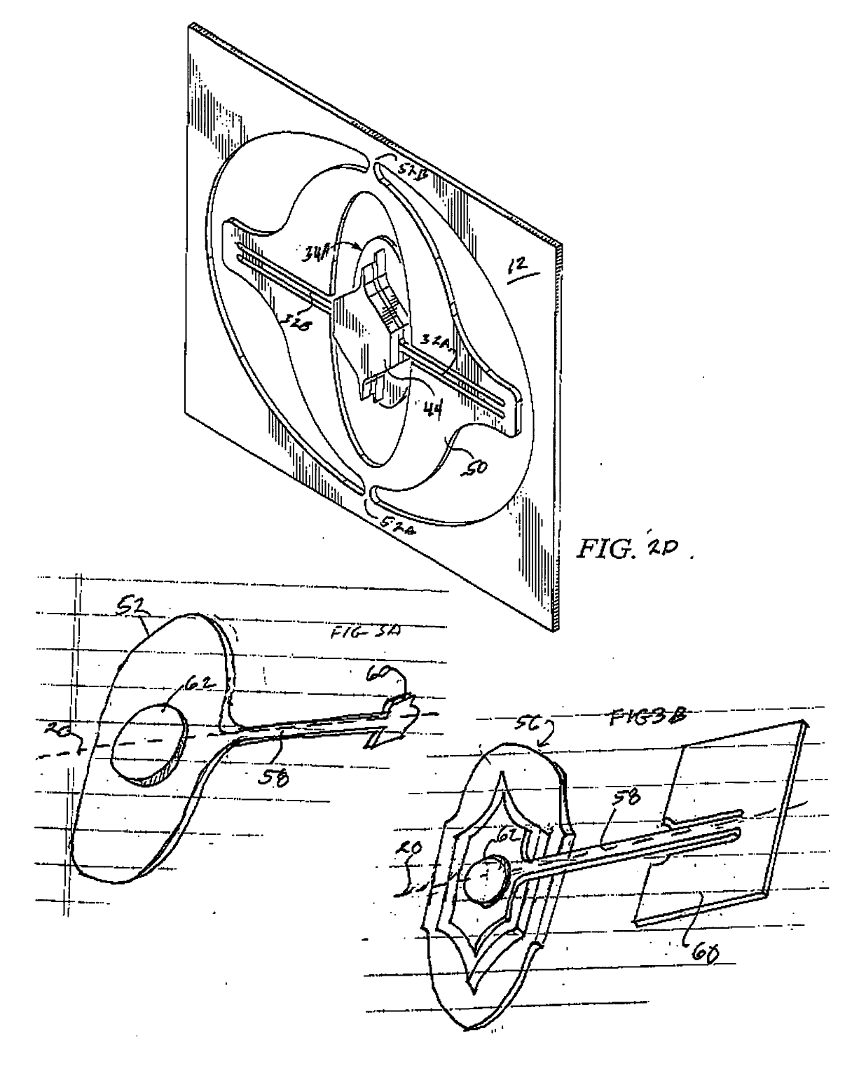

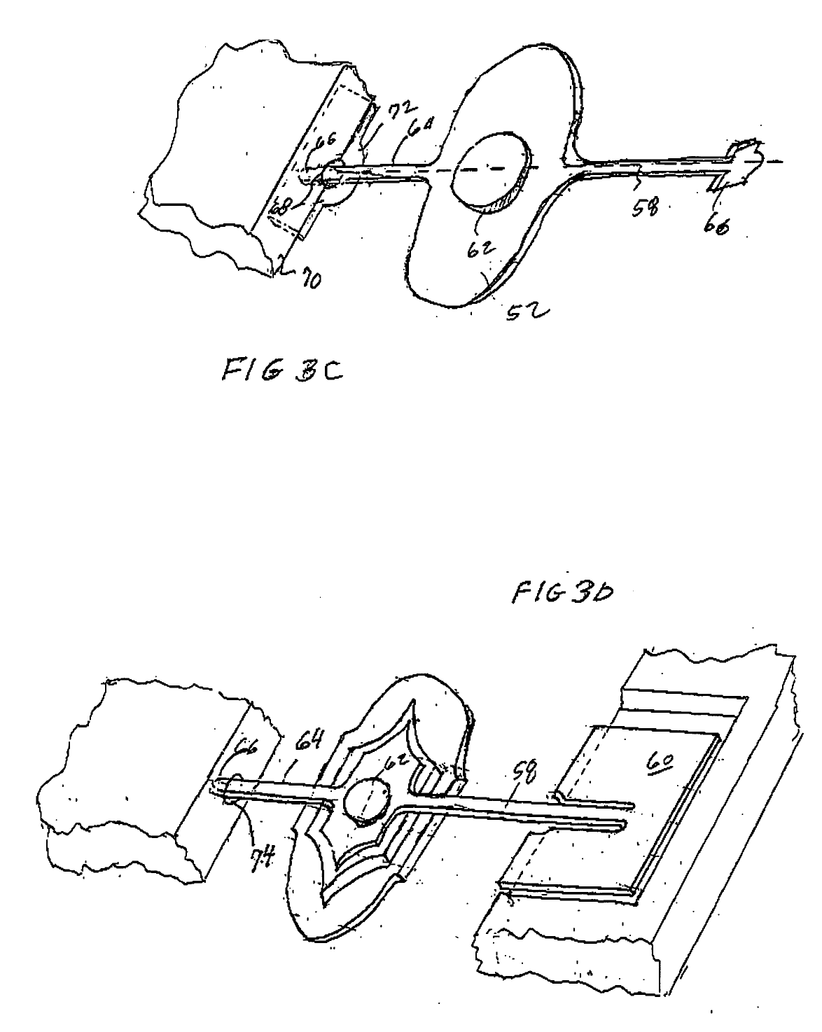

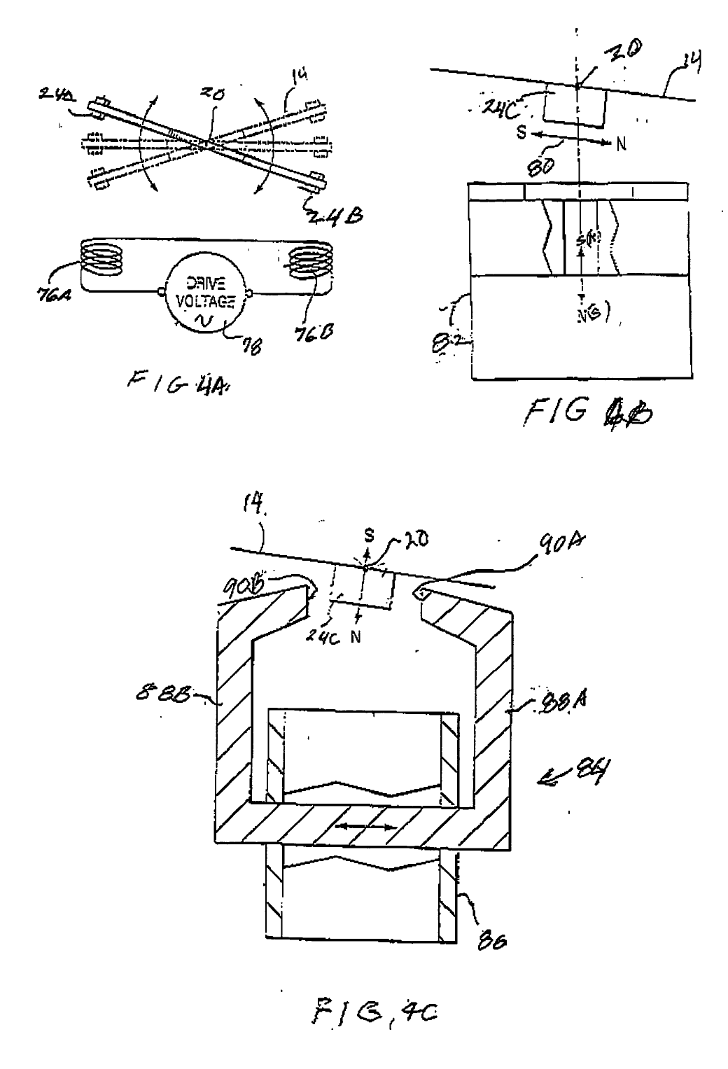

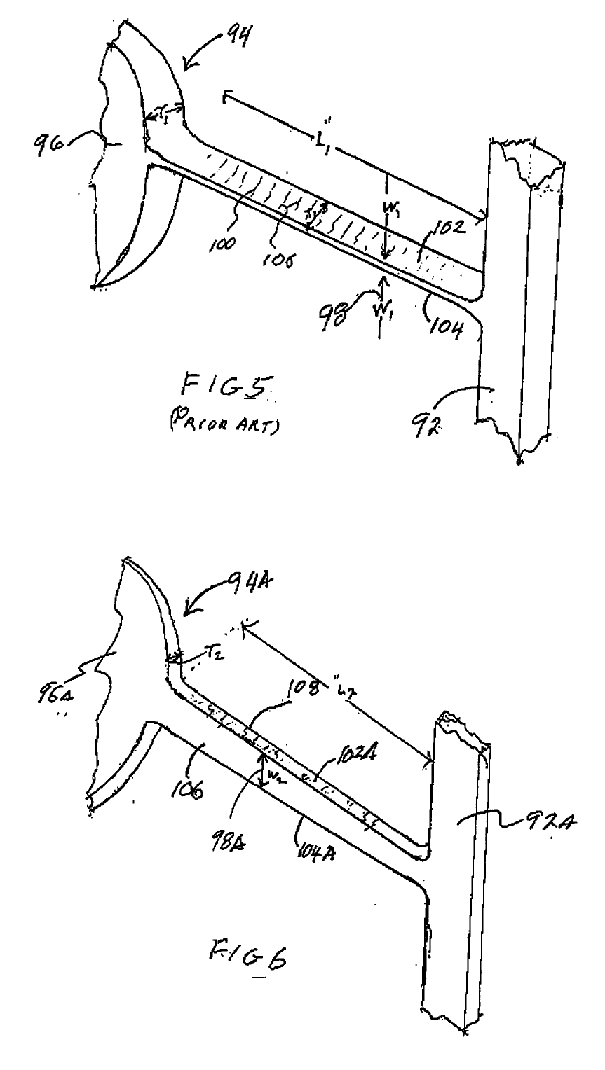

Various drive techniques have been used to generate the resonant frequency in torsional hinged devices, such as mirrors. Such drive techniques include magnetic, piezoelectric, etc. However, magnetic drives have been found to be particularly suitable. FIGS. 4A, 4B, and 4C illustrate three different magnetic drives that are particularly suitable for use with the present invention.

FIG. 4A is a schematic diagram illustrating how the resonant sweep and/or the orthogonal motion is controlled by electromagnetic coils 76a and 76b are driven by a power or voltage source 78, such as for example only, an alternating voltage source having a frequency substantially the same as the resonant frequency of the mirror. The permanent magnet sets 24a and 24b, such as discussed above with respect to FIGS. 1A and 2A, may be bonded to the mirror portion 14 (or gimbals member 50 shown in FIG. 2A) such that they cooperate with electromagnetic coils 76a and 76b. Thus, in the example of an alternating voltage, as the two coils 76a and 76b switch back and forth between north and south polarities, the permanent magnets 24a and 24b are alternately repelled and attracted to create the movement and/or resonant oscillation about axis 20. If the coil arrangement and magnet pairs are to provide orthogonal movement along axis 48 shown in FIG. 2A, a much slower frequency is used.

Referring now to FIG. 4B, there is a simplified illustration of a pivoting mirror 14 and another coil and permanent magnet arrangement that significantly reduces the moment of inertia of the apparatus. As shown, the two permanent magnets have been eliminated and a single magnet 24c is centrally mounted on the pivoting mirror (such as shown in FIG. 2B). According to the embodiment shown in FIG. 4B, magnet 24C has a diametral charge that is perpendicular to the axis of rotation, as illustrated by double-headed arrow 80, rather than an axial charge. It will, of course, also be necessary to relocate the single drive coil 82 of the electromagnetic device so that it is substantially below magnet 24c. Therefore, as the electromagnetic coil 82 switches back and forth between a north and south polarity, the “N” and “S” diametrally charged poles of permanent magnet 24c are alternately repelled and attracted thereby causing pivotal oscillations about axis 20.

FIG. 4C shows a second drive arrangement suitable for use with a single magnet centrally located. As shown, magnet 24c is axial charged in this embodiment instead of the diametral charged magnet of FIG. 4B. Further, the coil 82 shown in FIG. 4B is replaced by an electromagnetic arrangement 84, having a coil 86 and leg members 88a and 88b that extend from the coil 86 to tips 90a and 90b on each side of the magnet 64. Thus, an alternating current applied to coil 86 causes the magnetic field at the tips 90a and 90b of legs 88a and 88b to continuously change polarity. This change in polarity creates alternating push-pull forces on axial charged magnet 24c.

Referring now to FIG. 5, there is illustrated an enlarged view of a torsional hinge used to support a mirror device as fabricated according to the prior art. As shown, there is an anchor portion 92 and a functional portion 94, such as for example a mirror, having a reflective surface 96. The device is etched from a silicon wafer having a thickness “T₁”, and therefore, the various components or portions of the mirror also typically have a thickness “T₁”. It will be appreciated, however, that it would be possible to further etch portions of the mirror to selectively reduce the thickness of selected portions of the torsional device or mirror. As shown, the width “W₁” of the hinge indicated by double arrows having reference number 98 is selected to be substantially less than the thickness “T₁”. Since the resonant frequency of a torsional hinges device varies with the thickness “T₁”, the width “W₁”, and the length “L₁” of the hinge(s), substrates or wafers on the order of between about 90 microns and 120 microns in thickness “T” are selected to provide robust hinges. The width “W” along with the length “L” were then varied to control the resonant frequency of the device.

It has been discovered, however, that the striations indicated at 100 on the surfaces 102 and 104 of the prior art hinge resulting from the etching process act as stress concentrators and, consequently, represent the likely failure point of a failed hinge.

Referring now to FIG. 6 there is illustrated a torsional hinge device manufactured according to the teachings of the present invention. As can be seen, the silicon wafer may be selected to have a thickness “T₂” that is less that the wafer thickness of the prior art device. Further, the width “W₂” is substantially increased such that dimension “W₂” is greater than the dimension “T₂”. That is, the ratio W₂/T₂ is greater than 1. Therefore the largest dimension of the hinge is on the top and bottom polished surfaces 106 and 108. Consequently, even though the etched surfaces 102a and 104a still have stress concentration striations, since the maximum stress of the hinge is at the largest dimension, which is polished, there are minimum stress concentrators on the polished hinge surfaces 106 and 108 resulting in an even more robust hinge with a longer operating life. According to one embodiment, the wafer width “W₂” is selected to be greater than the wafer thickness “T₂” such that the ratio W₂/T₂ is 1.1 or greater. Thus, if the thickness T₂ of the wafer is between about 75 microns to 100 microns, the width “W₂” of the hinge should be no less than about 82.5 microns and 110 microns.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A torsional hinged device etched from a silicon wafer having a thickness “T” and at least a polished top surface, said torsional hinged device comprising:
an anchor member;
a functional portion; and
at least one torsional hinge member extending between said anchor member and said functional portion, said torsional hinge having a cross-section comprising a top and bottom surface separated by a thickness “T”, corresponding to said top and bottom polished surfaces of said wafer and etched side wall surfaces, separated by a second dimension or width “W” parallel to said top and bottom polished surfaces wherein said dimension “W” is greater than said dimension “T”.

2. The torsional hinged device of claim 1 wherein both the top and bottom surfaces of the silicon wafer are polished.

3. The torsional hinged device of claim 1 wherein said functional portion is a mirror.

4. The torsional hinged device of claim 1 wherein said at least one torsional hinge is a single or half hinge.

5. The torsional hinged device of claim 2 wherein said at least one torsional hinge is a single or half hinge.

6. The torsional hinged device of claim 3 wherein said at least one torsional hinge is a single or half hinge.

7. The torsional hinged device of claim 1 wherein said at least one torsional hinge comprises two torsional hinges each extending along a selected axis from said functional surface to an anchor.

8. The torsional hinged device of claim 2 wherein said at least one torsional hinge comprises two torsional hinges each extending along a selected axis from said functional surface to an anchor.

9. The torsional hinged device of claim 3 wherein said at least one torsional hinge comprises two torsional hinges each extending along a selected axis from said functional surface to an anchor.

10. The torsional hinged device of claim 1 wherein the ratio of width W to the thickness “T” is greater than 1.1.

11. The torsional hinged device of claim 2 wherein the ratio of width W to the thickness “T” is greater than 1.1.

12. The torsional hinged device of claim 3 wherein the ratio of width W to the thickness “T” is greater than 1.1.

13. A method of fabricating a torsional hinged device from a silicon wafer having a thickness “T” and a polished top and bottom surface, said method comprising the steps of:
providing a silicon wafer having a thickness “T” with at least a polished top surface; and
etching a device having at least one torsional hinge with a rectangular cross-sectional shape with a thickness dimension “T” between the top and bottom surfaces of said silicon wafer a width “W” between etched side walls of said hinge, wherein said width “W” dimension is greater than said thickness dimension “T”.

14. The method of claim 13 further comprising polishing the bottom surface of said silicon wafer.
